(19) United States
(12) Patent Application Publication
(10) Pub. No.: US 2003/0038220 A1
(43) Pub. Date: Feb. 27, 2003

(54) Handbag holder for use on tables

(76) Inventor: Robert S. Catan, Boca Raton, FL (US)

Correspondence Address: Robert S. Catan, 10141 Umberland Pl., Boca Raton, FL, 33428, US

(21) Appl. No.: 09/919,337

(22) Filed: Jul. 31, 2001

(51) Int. Cl. F16B 45/00

(52) U.S. Cl. 248/304; 248/914

(57) ABSTRACT

A utility hook holds a handbag under a table. The hook includes a hanger that hangs from foot linked by a pivot joint with at least one axis of freedom. The part of the hook from which the strap of the handbag may be hung is located directly below the axis of pivot in such a way as to naturally align the hanger with a minimum of extension beyond the table. The foot may be rotated to align its major plane with that of the hanger to form a compact arrangement.

### BACKGROUND OF THE INVENTION

1. Field of the Invention

The invention relates to utility hooks and particularly to such hooks as may be used to hold a lady's handbag or shoulder bag beneath a table and off the floor.

2. Background

When visiting a restaurant, users of shoulder bags and handbags are generally faced with the problem of where to place the bag. The most common solutions are to hold the bag in the lap or put it on the floor. Both options are undesirable from the standpoint of comfort and cleanliness. Also, a bag placed on the floor may be awkward to pick up if the owner requires access to it, such as when paying the restaurant bill. Also, children playing on the floor of a host's house might invade the privacy of a guest who has left his/her bag on the floor. Security is also a problem in this context, particularly when visiting high tourist traffic locales.

Utility hooks have been proposed for holding handbags under tables and off the floor. For example, GR92100190A discloses a utility hook for suspending a lady's handbag below a table. The hook is described as having a table-shaped metallic head with a semicircular arm 8.5 cm. long that loops from the table top to a point beneath the table. The table-shaped head has a foam surface to make anti-friction contact with the table's surface. This hook will hold a handbag off the floor, but it extends out from the table unnecessarily owing to its semicircular shape. Also, no means is provided to insure the anti-friction foam can do its job since an off-center load may tip table shaped head. In addition, table-shaped head is obstructive when the hook is placed in a handbag, making it space-consuming and prone to getting caught on other items in the user's carry bag. Still further, most handbag straps connected the longitudinal extremes of a handbag. Such a strap hooked over this hook will cause the handbag to tend to hang with its long dimensional parallel the edge of the table (or parallel to the tangent of a round or curvilinearly edged table).

Another prior art handbag holder is described in U.S. Pat. No. 4,210,302. This is an asymmetrical U-shaped hook when its arms are extended, the two arms being horizontal when in use and the joining element being generally vertical. The device is foldable for compactness when storing it. The design's asymmetric horizontal elements, the two arms of the U-shape are such that the vertical element must hang at an angle because the center of mass tends to move directly below the end of the top arm. This causes the vertical joining element to tend to be at an angle so that the device juts out from the table when in use. The device has a rubber friction foot that can pivot, but according to the drawing, not when in use. This is because the hinge is shaped to lock when the handbag's center of mass moves itself directly below the support point on top of the table. The hinge appears to be an adaptation for very deep tabletops or ones with no space beneath them.

Another hook for purses and similar articles is shown in the US Design Patent 314,864. This device is a U-shaped bracket with very little vertical depth which may not permit a very deep table to be accommodated in the recess access. Also it holds the straps in such an arrangement with respect to the edge of the table as to make the bag tend to align itself parallel to the edge of the table and perpendicular to the legs of a seated person. Also, the design in bulky and fails to make optimum use of the upper engagement surface to prevent slips.

### SUMMARY OF THE INVENTION

The invention provides a constellation of features centering around a utility hook for hanging articles from a table. These features address the problems of the prior art.

According to an embodiment, the invention comprises a foot with a generally flat surface engageable with the top of a table pivotally attached at the end of a U-shaped element with a cylindrical cross-section. When in engagement with the table, the U-shape has two horizontal elements and joined by a vertical element. The upper of the horizontal elements is pivotally attached to the foot. The lower of the horizontal elements is slightly longer than the upper horizontal element so that when the handbag is hanging from the lower element near its end, the center of the strap is immediately below the pivot point and when the bag is balanced, the vertical element is precisely vertical. The foot has a non-friction cushion surface. Because of the pivot, the foot rests flat with a uniform load on the cushion, thereby minimizing wear on the non-friction surface.

In an alternative variation on the above embodiment, the upper horizontal element has a right angle bend and a short horizontal section terminating a short distance from an axis of the upper horizontal element where the pivot connection joins with it with the foot. The lower horizontal element also has a short horizontal section that is parallel to the one following the right angle bend on the upper horizontal element. The lower one is longer than the upper one so that when a handbag is placed in the middle of the lower short horizontal section, the center of mass lies directly below the pivot point with the vertical element oriented precisely vertical. In this way, the strap of the bag tends to arrange itself perpendicular to the edge of the table thereby making the longest dimension of most bags parallel to the legs of an adjacent seated person.

According to other features of the invention, the device has a universal joint as its pivot to permit the foot to rest at odd angles for table surfaces that are uneven or which have obstructions or molding. Also, according to another feature, the invention may include a pivot that is off-center relative to the foot so that a table surface that slopes downwardly away from the center of the table top will spread the pressure evenly over the surface of the foot most remote from the pivot.

The off-center arrangement of the pivot will also assist engagement of the foot when the handbag is hung toward the blind end of recess defined by the-shape rather than toward the end of the lower horizontal element. When a bag is so hung, the lower end of the vertical element tends to rest against the table generating a shear stress on the foot-table engagement interface that has a component directed perpendicular to the edge of the table and away from the table. The off-center alignment spreads the pressure more evenly over the foot when the hook is used in this way.

Still other optional features facilitate the connection of the utility hook of the invention to a keychain. Others facilitate manufacturability. For example, a universal pivot joint (two-axes) allows the foot to arrange itself generally parallel to the vertical element to create a flat profile for easy stowage. A button on the end of the hook prevents the bag from slipping off. An optional engagement lock holds bags with long straps so that they can be kept off the floor.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1A is a top view of a utility hook according to a first embodiment of the invention.

FIG. 1B is a side view of the embodiment of FIG. 1A.

FIG. 2 is side view of a second embodiment of the invention in which an off-center pivot point corrects for beveled surfaces on a supporting table.

FIG. 3 is a side view of the embodiment of FIG. 3 illustrating the forces involved in misalignment of a load on the embodiment of FIG. 2.

FIG. 4 is a figurative oblique view of showing the axes of the runs of a utility hook according to another embodiment of the invention.

FIG. 5A is a top view, with a partial cutaway, of a utility hook having a self-closing cam clamp according to another embodiment of the invention.

FIG. 5B is a side view of the embodiment of FIG. 5A.

### DETAILED DESCRIPTION OF THE PREFERRED EMBODIMENTS

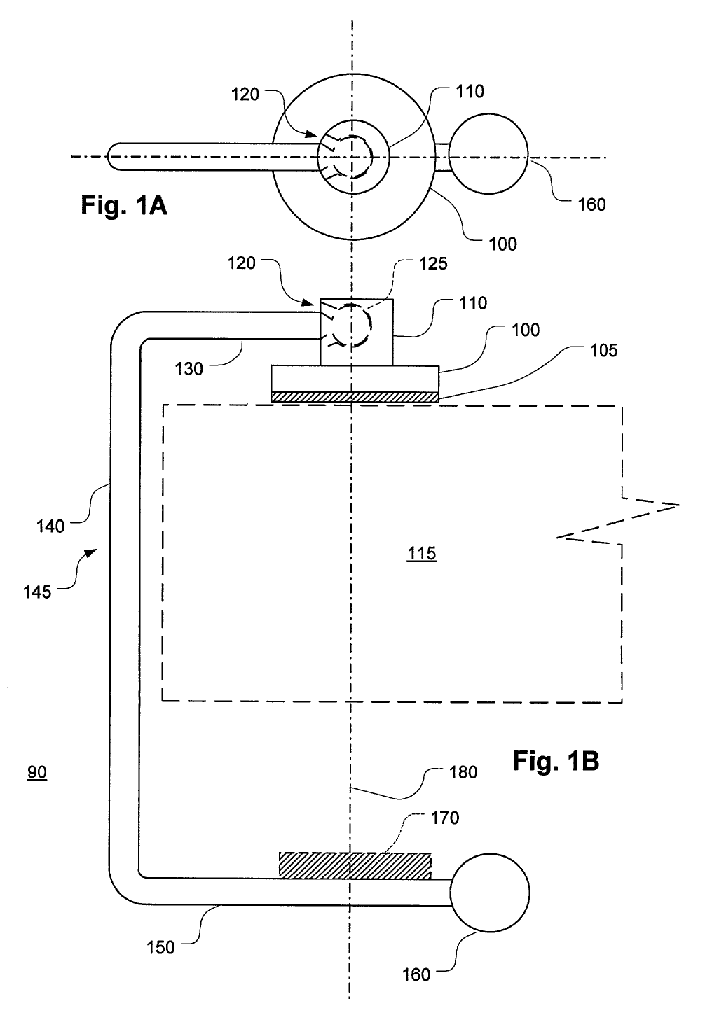

Referring to FIGS. 1A and 1B, a utility hook 90 has foot 100 with a no-slip cushion 105 having a high friction coefficient. The foot 100 is connected to a U-shaped hanger 145 defined by top and bottom horizontal portions 130 and 150, respectively, which are connected by a vertical portion 140. The U-shaped hanger 145 is connected to the foot 100 via a pivot joint 120 which may consist of a ball and socket arrangement 125 giving two axes of mobility as illustrated. A vertical axis of the ball and socket arrangement 125 is indicated at 180.

The foot 100 is placed so that the no-slip cushion rests on a table 115. The lengths of the top and bottom horizontal portions 130 and 150 are such that the strap of a handbag 170 resting on the horizontal portion 150 may be centered with respect to the vertical axis 180. Assuming the weight of the handbag is much greater than that of the U-shaped hanger 145, the centering of the strap of the handbag with respect to the vertical axis 180 will cause the vertical portion to align itself precisely with the vertical with no moment requiring to be countered by contact with the table. This is so even if the surface of the table 115 is uneven, the pivot joint 120 may compensate for the uneven surface and the vertical portion 140 will remain vertical without the U-shaped hanger 145 contacting the table 115.

A button 160 is located at the end of the U-shaped hanger 145 to prevent the strap 170 from slipping off. Note that instead of a button 160, the bottom horizontal portion 150 could be shaped with a bend at its distal end to perform the same function or it could be shaped as a curve whose lowest point coinciding, preferably, with the vertical axis 180.

The U-shaped hanger 145 is preferably formed of rod stock and given a bright finish to permit it to be found easily in a deep handbag. The pivot joint 120 preferably permits the major plane of the foot 100 surface to rotate about an axis parallel to the horizontal portion so that the plane of the foot 100 and the plane defined by the continuous axis of the U-shaped hanger 145 may be arranged parallel permitting the entire utility hook 90 to assume a generally flat package. The latter configuration may be preferred for stowage in the pocket of a bag or wallet.

An alternative to the foot 100 with pivot joint 120 is a rounded surface on a foot that is fixedly attached to the U-shaped hanger 145. An alternative to the pivot joint 120 is a hinge that permits pivoting about an axis perpendicular to the above-described plane defined by the continuous axis of the U-shaped hanger 145. The latter would accommodate radial gradients in the table surface (assuming a round table). A combination of the foregoing a rounded foot 100 surface and a single axis pivot, may provide the ability to accommodate tangential gradients in the table 115 surface.

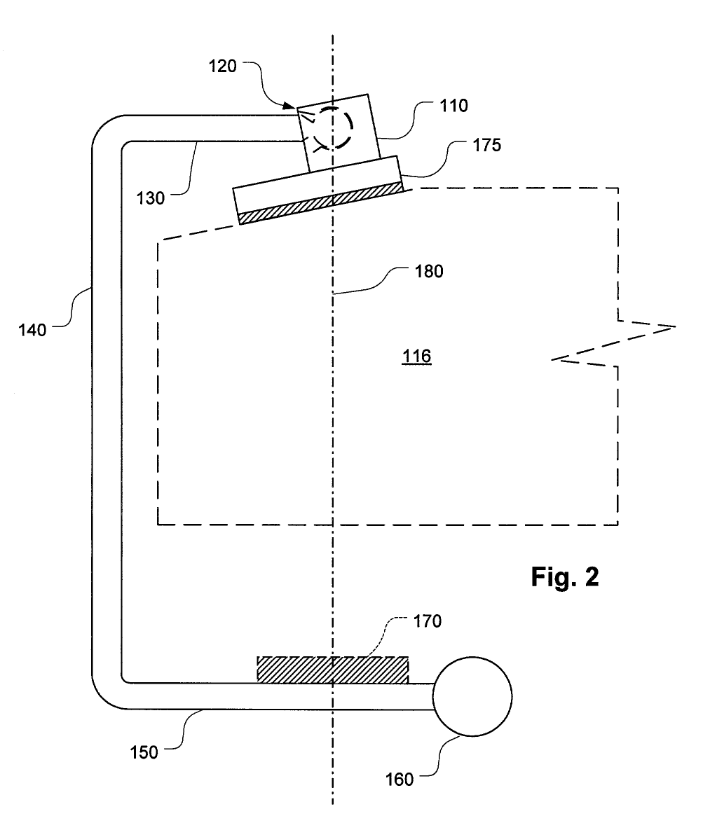

Referring to FIGS. 2, an alternative embodiment has a foot 175 that is asymmetrically arranged with respect to the vertical axis 180 of the pivot joint 120. On a table 116 with a negative radial gradient surface, the foot 175 provides a more stable surface than one that is centered like the embodiment of FIGS. 1A and 1B. This-is because a shear stress is generated in addition to the normal force caused by the weight of the handbag. That shear stress results in a moment about the pivot axis whose direction is radial with respect to the table 116. This moment is better resisted by the extended surface of the foot 175 in the direction of the shear stress.

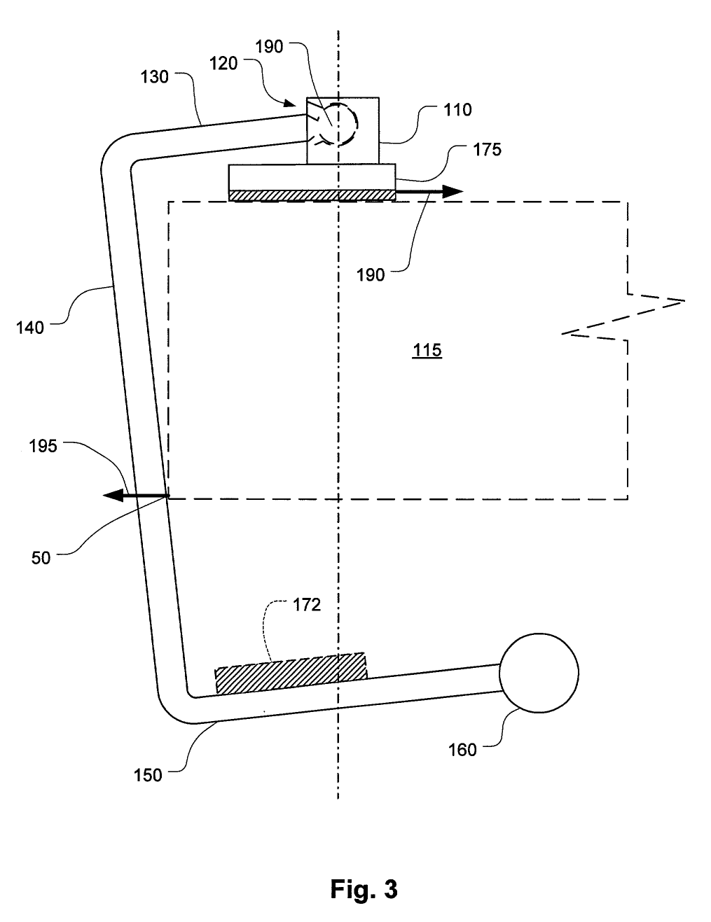

Referring to FIG. 3, the same moment may result when the handbag strap 170 is placed near the bend joining the vertical portion 140 and the bottom horizontal portion 150 of the U-shaped hanger 145. The moment is caused by the misalignment of the weight of the handbag and the vertical axis of the pivot joint 120. This in turn is resisted by the table at a point of contact between the table 115 and the vertical portion 140 of the U-shaped hanger 145. The two forces illustrated by the vectors 190 and 195 cancel with the former being supported by friction between the foot 175 and table 115. Again the eccentric alignment of the foot 175 and the vertical axis 180 improves the grip of the foot 175 on the table 115.

Referring to FIG. 41 an alternative embodiment is illustrated by only the central axis of a U-shaped hanger 245. This embodiment is similar to that of FIGS. 1A and 1B, except that there are two further horizontal sections 225 and 255 of a U-shaped hanger represented by the central axis 245. These two are horizontal but they are perpendicular extensions to the top and bottom horizontal sections of the embodiment of FIGS. 1A and 1B. The horizontal section represented by the axis segment 255 supports the handbag strap 170 arranged at the center of the pivot axis 280 which passes through a pivot joint represented by the point 200. The pivot joint may be like the one of the embodiment of FIGS. 1A and 1B. The advantage of the extensions 225 and 255 of this embodiment is that it allows the long axis of the strap 170 to be arranged parallel to a radius of the table. In this way, the strap 170 and the long axis of a handbag, which are usually parallel in most handbags, may be substantially parallel to the legs of people sitting adjacent one another. The result may be that the handbag takes up a minimum of space when used with the utility hook of this design.

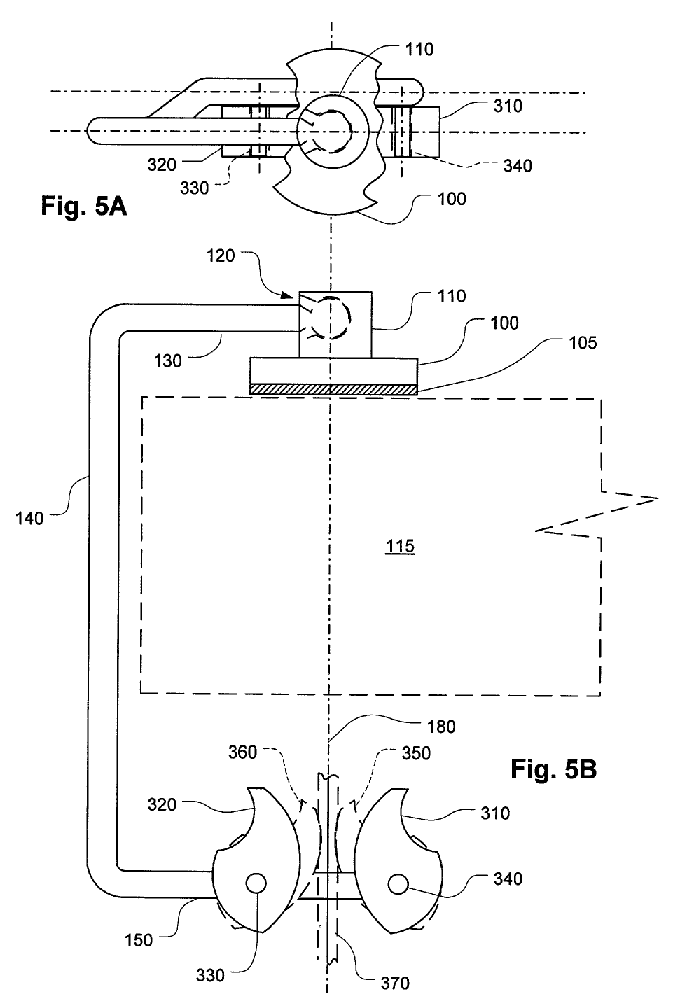

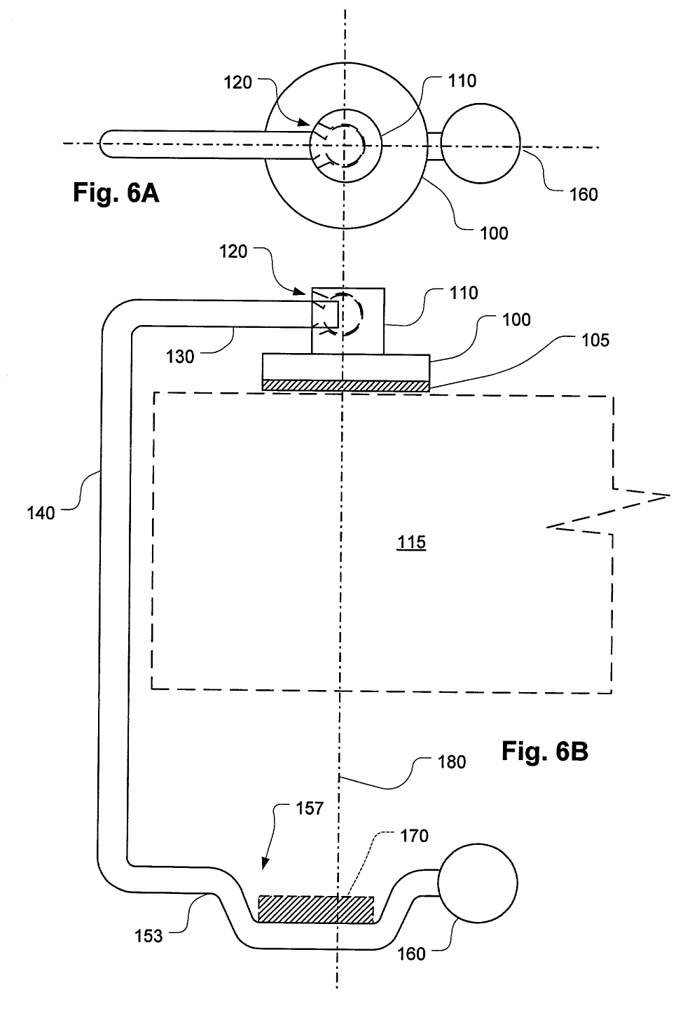

Referring to FIGS. 5A and 5B, the handbag may be arranged with its long axis in the radial direction using another embodiment. In this embodiment, the bag strap 370 is pinched between cams 310 and 320 that form a passive clamp. The cams 310 and 320 may be urged toward the positions indicated at 350 and 360 by respective springs (not shown). The weight of the handbag may help to secure the cams 310 and 320 in a locking cooperation that holds the strap 370 securely. In this embodiment, a very long strap may be accommodated, thereby preventing the bag from hitting the floor.

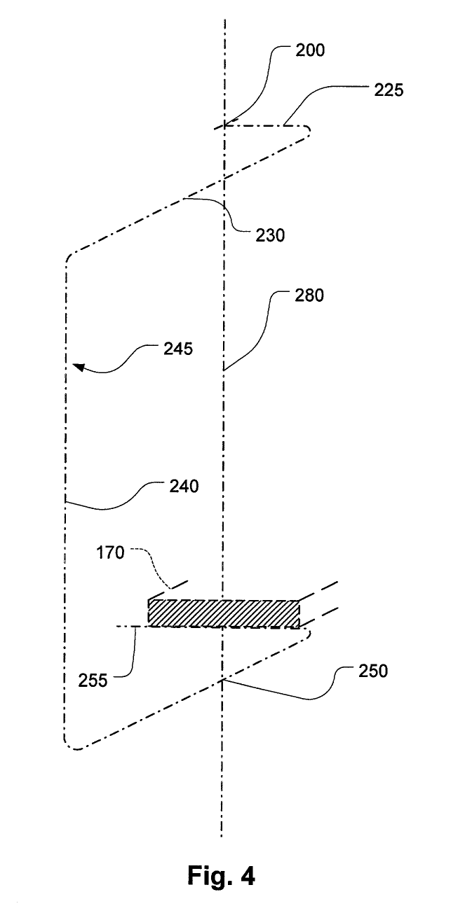

Referring to FIGS. 6A and 6B, in a refinement of the design of FIGS. 1A and 1B, a recess 157 is formed in the bottom horizontal portion 153 of a hanger. This recess 157 helps to locate the strap 170 so that it is centered with respect to the vertical axis 180. Note that this feature may be added to the embodiment of FIG. 4 as well.

Note that while the above discussion described the invention in terms of its use with a round table, the invention may be used in the same way with a rectilinear or any other shaped table.

While the present invention has been explained in the context of the preferred embodiments described above, it is to be understood that various changes may be made to those embodiments, and various equivalents may be substituted, without departing from the spirit or scope of the invention, as will be apparent to persons skilled in the relevant art.

What is claimed is:

1. A utility hook, comprising:
a foot having a surface by which said foot may rest on a table;
a generally U-shaped hanger pivotally connected to a foot by a pivot joint permitting two axes of movement;
said pivot joint having a center of rotation;
said U-shaped hanger having a portion permitting a strap of a handbag to hang therefrom;
said U-shaped hanger being shaped such as to permit said strap of said handbag to be aligned with a vertical axis passing through said center of rotation.

2. The hook of claim 1, further comprising a cushion on said foot, said surface of said foot being a surface of said cushion.

3. The hook of claim 2, wherein:
said U-shaped hanger has two parallel horizontal portions joined by a vertical portion; and
said foot is eccentric with respect to said pivot joint such as to provide a greater contact area between said foot and said table on a side toward a vertical portion than on a side opposite said vertical portion.

4. The hook of claim 1, wherein:
said U-shaped hanger has two parallel horizontal portions joined by a vertical portion; and
said U-shaped hanger is shaped in such a way that said handbag strap is aligned substantially parallel to said two horizontal portions, whereby a longitudinal aspect of said handbag is parallel to said two horizontal portions and perpendicular to said table.

5. The hook of claim 3, further comprising a cushion on said foot, said surface of said foot being a surface of said cushion.

6. The hook of claim 1, wherein said U-shaped hanger is of generally uniform circular cross section.

7. The hook of claim 1, further comprising a cam clamp into which said strap may be clamped.

8. The hook of claim 7, wherein:
said U-shaped hanger has two parallel horizontal portions joined by a vertical portion; and
said foot is eccentric with respect to said pivot joint such as to provide a greater contact area between said foot and said table on a side toward a vertical portion than on a side opposite said vertical portion.

9. The hook of claim 6, wherein said U-shaped hanger is of generally uniform circular cross section.

10. The hook of claim 1, further comprising a cam clamp into which said strap may be clamped.

11. The hook of claim 1, wherein said foot has a major plane and said pivot joint is such as to align said foot major plane with a major plane of said U-shaped hanger.

12. A utility hook, comprising:
a foot having a surface by which said foot may rest on a table;
a generally U-shaped hanger pivotally connected to a foot by a pivot joint permitting two axes of movement;
said pivot joint having a center of rotation;
said U-shaped hanger having a portion permitting a strap of a handbag to hang therefrom;
said U-shaped hanger being shaped such as to urge said strap of said handbag to be aligned with a vertical axis passing through said center of rotation.

13. The hook of claim 12, wherein:
said U-shaped hanger has two parallel horizontal portions joined by a vertical portion; and
said foot is eccentric with respect to said pivot joint such as to provide a greater contact area between said foot and said table on a side toward a vertical portion than on a side opposite said vertical portion.

14. The hook of claim 12, wherein said U-shaped hanger has upper and lower horizontal portions joined by a vertical portion and said lower horizontal portion is shaped with a recess that urges said strap of said handbag so to be aligned with said vertical axis when said strap is hanging therefrom.

15. The hook of claim 12, wherein said foot has a major plane and said pivot joint is such as to align said foot major plane with a major plane of said U-shaped hanger.

16. A utility hook, comprising:
a foot having a surface by which said foot may rest on a table;
a generally U-shaped hanger pivotally connected to a foot by a pivot joint permitting at least one axis of pivoting;
said pivot joint having a center of pivoting;
said U-shaped hanger having a portion permitting a strap of a handbag to hang therefrom;
said U-shaped hanger being shaped such as to permit said strap of said handbag to be aligned with a vertical axis passing through said center of pivoting.

17. The hook of claim 16, further comprising a cushion on said foot, said surface of said foot being a surface of said cushion.

18. The hook of claim 16, wherein:
said U-shaped hanger has two parallel horizontal portions joined by a vertical portion; and
said U-shaped hanger is shaped in such a way that said handbag strap is aligned substantially parallel to said two horizontal portions, whereby a longitudinal aspect of said handbag is parallel to said two horizontal portions and perpendicular to said table.

19. The hook of claim 18, further comprising a cushion on said foot, said surface of said foot being a surface of said cushion.

20. The hook of claim 16, wherein said U-shaped hanger is of generally uniform circular cross section.

21. The hook of claim 13, further comprising a cam clamp into which said strap may be clamped.

22. The hook of claim 18, wherein said U-shaped hanger is of generally uniform circular cross section.

23. The hook of claim 16, further comprising a cam clamp into which said strap may be clamped.

24. The hook of claim 16, wherein said foot has a major plane and said pivot joint is such as to align said foot major plane with a major plane of said U-shaped hanger.

25. The hook of claim 16, wherein:
said U-shaped hanger has two parallel horizontal portions joined by a vertical portion; and
said foot is eccentric with respect to said pivot joint such as to provide a greater contact area between said foot and said table on a side toward a vertical portion than on a side opposite said vertical portion.
